(19) United States
(12) Patent Application Publication
(10) Pub. No.: US 2026/0231193 A1
(43) Pub. Date: Aug. 6, 2026

(54) CARRIER SELECTION AND RESTRICTION FOR DUPLICATION IN MULTIPATH RELAYING FOR DIFFERENT DATA FOR NEW RADIO (NR) RELAYS

(71) Applicant: INTERDIGITAL PATENT HOLDINGS, INC., Wilmington, DE (US)

(72) Inventors: Martino FREDA, Laval (CA); Oumer Teyeb, Montreal (CA); Tuong Hoang, Montreal (CA); Ananth Kini, Conshohocken, PA (US)

(73) Assignee: INTERDIGITAL PATENT HOLDINGS, INC., Wilmington, DE (US)

(21) Appl. No.: 19/153,049

(22) PCT Filed: Feb. 1, 2024
(86) PCT No.: PCT/US2024/014025

§ 371 Date: Aug. 1, 2025

Related U.S. Application Data
(60) Provisional application No. 63/442,604, filed on Feb. 1, 2023.

(51) Int. Cl. H04W 72/40; H04W 72/02; H04W 72/0453; H04W 72/54; H04W 80/02; H04W 92/18

(52) U.S. Cl. CPC H04W 72/40; H04W 72/02; H04W 72/0453; H04W 72/54; H04W 80/02; H04W 92/18

(57) ABSTRACT

A relay wireless transmit/receive unit (WTRU) may receive, from a base station, an adaptation layer configuration which maps an incoming sidelink (SL) logical channel (LCH) to one or more Uu LCHs. The WTRU may receive, from the base station, a configuration of a set of allowable carriers for each of the incoming SL LCHs of each remote WTRU. The relay WTRU may receive, from one or more remote WTRUs, an indication of whether carrier restriction is required for a SL LCH. Also, the relay WTRU may select one or more carrier(s) for transmission of data for the Uu LCH from the intersection of the allowable carriers of each of the remote WTRU's SL LCHs that map to the Uu LCH, and which have the need for carrier restriction signaled by the remote WTRUs. Further, the relay WTRU may then transmit the data using the Uu LCH on the selected carrier(s).

### CROSS-REFERENCE TO RELATED APPLICATION

This application claims the benefit of U.S. Provisional Application No. 63/442,604, filed Feb. 1, 2023, the contents of which are incorporated herein by reference.

### BACKGROUND

Sidelink communication includes direct communication between devices, such as wireless transmit/receive units (WTRUs). Sidelink communication use cases include vehicle-to-everything (V2X) use cases and other uses cases, such as for unmanned aerial vehicles (UAVs) or drones. New radio (NR) V2X operations have been developed. V2X communications may include one or more of vehicle-to-vehicle (V2V) communications, vehicle-to-pedestrian (V2P) communications, vehicle-to-infrastructure (V21) communications and Vehicle-to-Network (V2N) communications. V2X wireless transmit receive units (WTRUs) may engage in V2X communications.

NR sidelink communication includes unicast transmission, groupcast transmission and broadcast transmission. Sidelink relay is used to support a UE-to-network (U2N) relay function to provide connectivity to the network for a U2N remote WTRU. Sidelink relay supports both layer 2 (L2) and layer 3 (L3) U2N relay architectures.

### SUMMARY

A relay wireless transmit/receive unit (WTRU) may receive, from a base station, an adaptation layer configuration which maps an incoming sidelink (SL) logical channel (LCH) to one or more Uu LCHs. Further, the WTRU may receive, from the base station, a configuration of a set of allowable carriers for each of the incoming SL LCHs of each remote WTRU. The relay WTRU may receive, from one or more remote WTRUs, an indication of whether carrier restriction is required for a SL LCH. Also, the relay WTRU may select one or more carriers for transmission of data for the Uu LCH from the intersection of the allowable carriers of each of the remote WTRU's SL LCHs that map to the Uu LCH, and which have the need for carrier restriction signaled by the one or more remote WTRUs. Further the relay WTRU may then transmit the data using the Uu LCH on the selected one or more carriers.

In an example, the indication of whether carrier restriction is required for a SL LCH may be received via a medium access control (MAC) control element (CE). The relay WTRU may transmit the data to a base station, in an example. In another example, the relay WTRU may then transmit the data to a plurality of base stations.

In a further example, the relay WTRU may determine which carrier set to use for the restriction based on the number of carriers in the carrier set. Also, the relay WTRU may determine which carrier set to use for the restriction based on the quality of service (QoS) of the data associated with the remote WTRU. Moreover, the relay WTRU may determine which carrier set to use for the restriction based on the buffer status associated with LCHs with data received from the remote WTRU. In addition, the relay WTRU may determine which carrier set to use for the restriction based on the load at one or more remote WTRUs. Further, the base station may be a gNode B (gNB) in an example.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a protocol stack diagram illustrating an example user plane protocol stack for a layer 2 (L2) UE-to-network (U2N) relay;

FIG. 3 is a protocol stack diagram illustrating an example control plane protocol stack for an L2 U2N relay;

FIG. 4 is a processing diagram illustrating an example of packet duplication;

FIG. 5 is a system diagram illustrating an example of a WTRU selecting logical channels (LCHs) for a grant associated with allowed carriers;

FIG. 6 is a system diagram illustrating an example of a remote WTRU transmitting on one or more Uu carriers and a relay WTRU transmitting on one or more Uu carriers; and

FIG. 7 is a flow chart diagram illustrating an example of a relay WTRU performing carrier selection/logical channel prioritization (LCP) restriction for different data requiring different restrictions.

### DETAILED DESCRIPTION

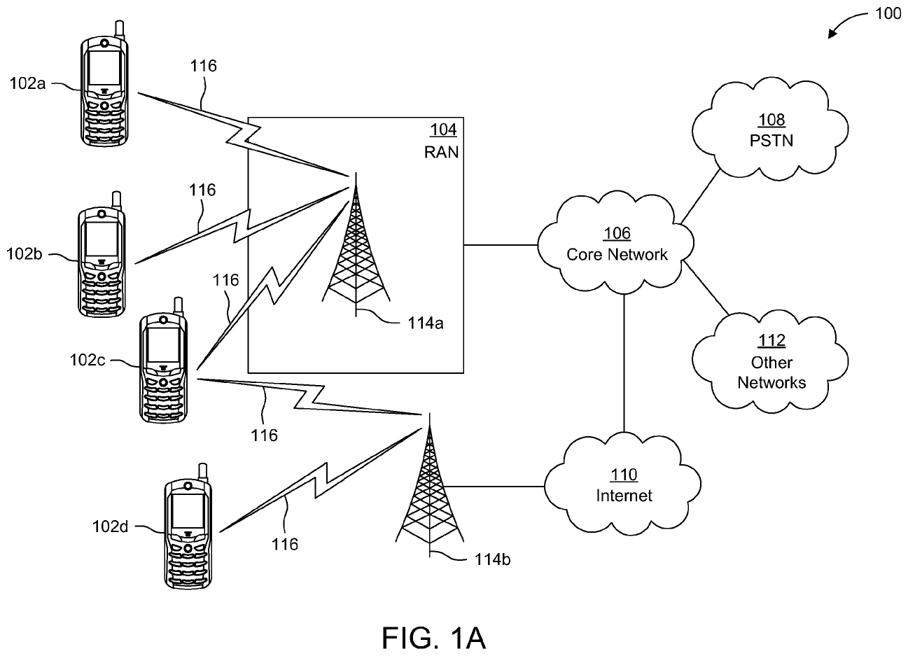

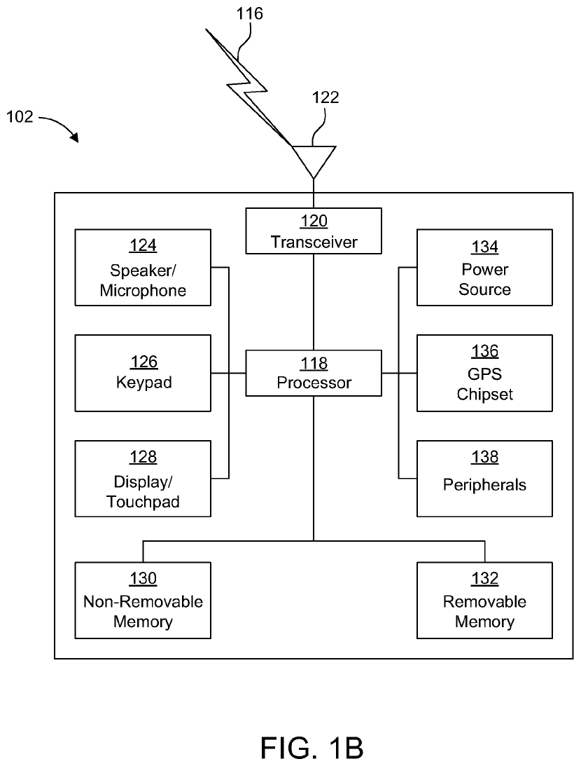

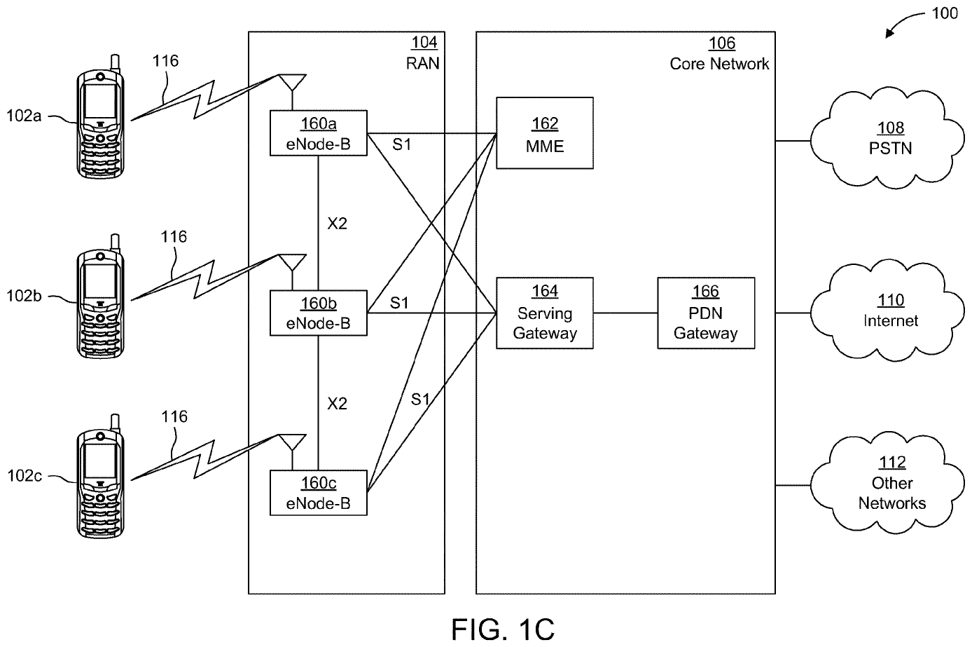

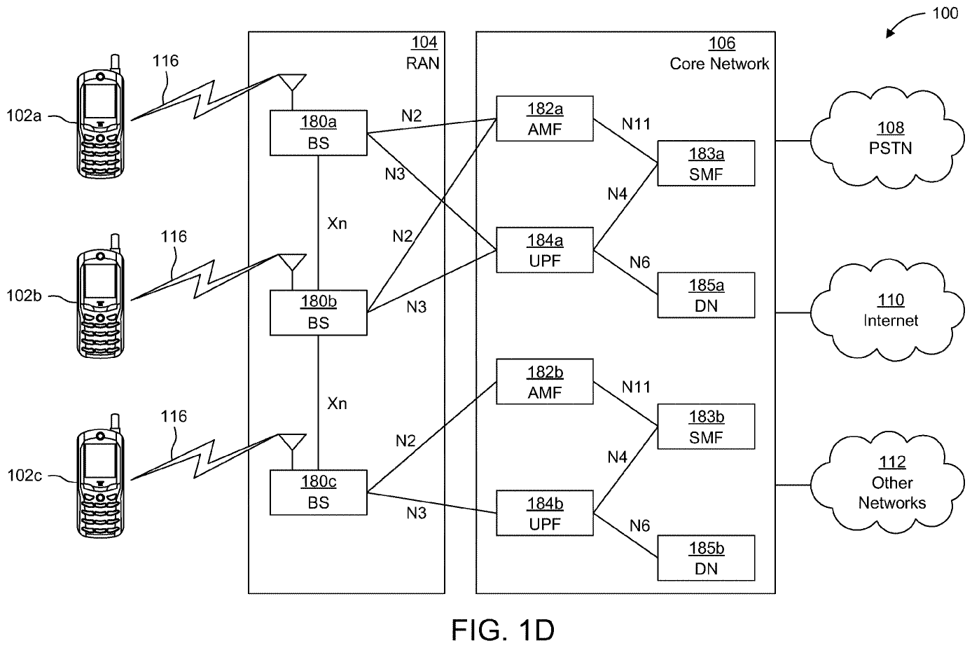

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (for example, radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (for example, an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (for example, for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (for example, WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANS, which may employ the same RAT as the RAN 104 or a different RAT.

Some or all of the WTRUs 102a, 102b, 102c, 102d in the communications system 100 may include multi-mode capabilities (for example, the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (for example, the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (for example, multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (for example, a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (for example, nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (for example, longitude and latitude) regarding the current location of the WTRU 102. In addition to, or in lieu of, the information from the GPS chipset 136, the WTRU 102 may receive location information over the air interface 116 from a base station (for example, base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (for example, associated with particular subframes for both the UL (for example, for transmission) and DL (for example, for reception) may be concurrent and/or simultaneous. The full duplex radio may include an interference management unit to reduce and or substantially eliminate self-interference via either hardware (for example, a choke) or signal processing via a processor (for example, a separate processor (not shown) or via processor 118). In an embodiment, the WTRU 102 may include a half-duplex radio for which transmission and reception of some or all of the signals (for example, associated with particular subframes for either the UL (for example, for transmission) or the DL (for example, for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (for example, temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (for example, directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (for example, all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (for example, 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (for example, every STA), including the AP, may sense the primary channel. If the primary channel is sensed/detected and/or determined to be busy by a particular STA, the particular STA may back off. One STA (for example, only one station) may transmit at any given time in a given BSS.

High Throughput (HT) STAs may use a 40 MHz wide channel for communication, for example, via a combination of the primary 20 MHz channel with an adjacent or nonadjacent 20 MHZ channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (for example, only support for) certain and/or limited bandwidths. The MTC devices may include a battery with a battery life above a threshold (for example, to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (for example, MTC type devices) that support (for example, only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUS 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (for example, containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (for example, such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (for example, handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (for example, testing) wired and/or wireless communication network in order to implement testing of one or more components. The one or more emulation devices may be test equipment. Direct RF coupling and/or wireless communications via RF circuitry (for example, which may include one or more antennas) may be used by the emulation devices to transmit and/or receive data.

Sidelink relay is used to support a UE-to-network (U2N) relay function to provide connectivity to the network for a U2N remote WTRU using a U2N relay WTRU. Sidelink relay supports both layer 2 (L2) and layer 3 (L3) U2N relay architectures. A U2N relay architecture may include a user plane protocol stack and a control plane protocol stack as explained further below.

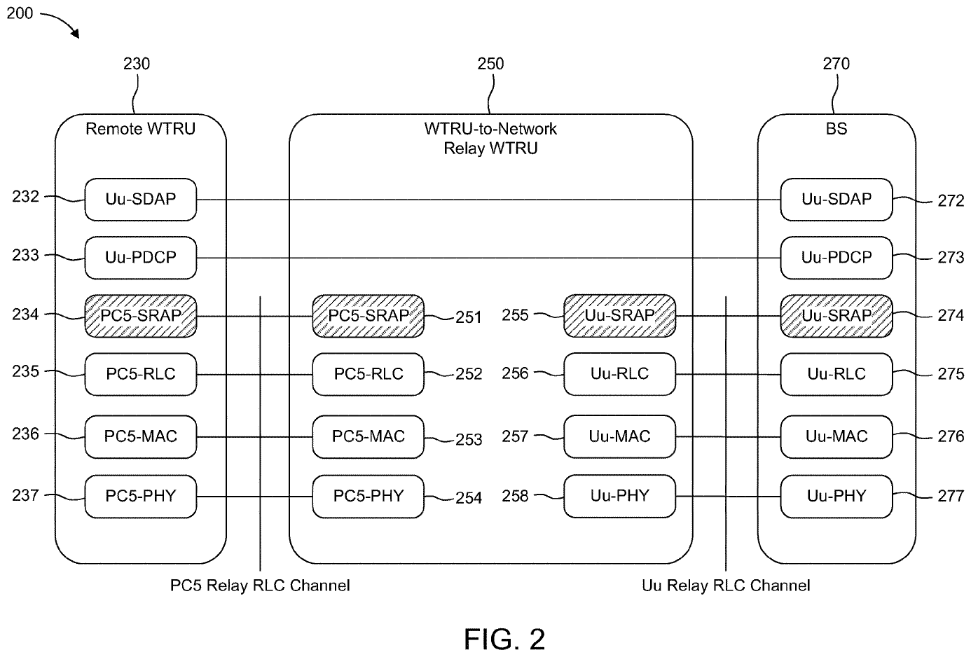

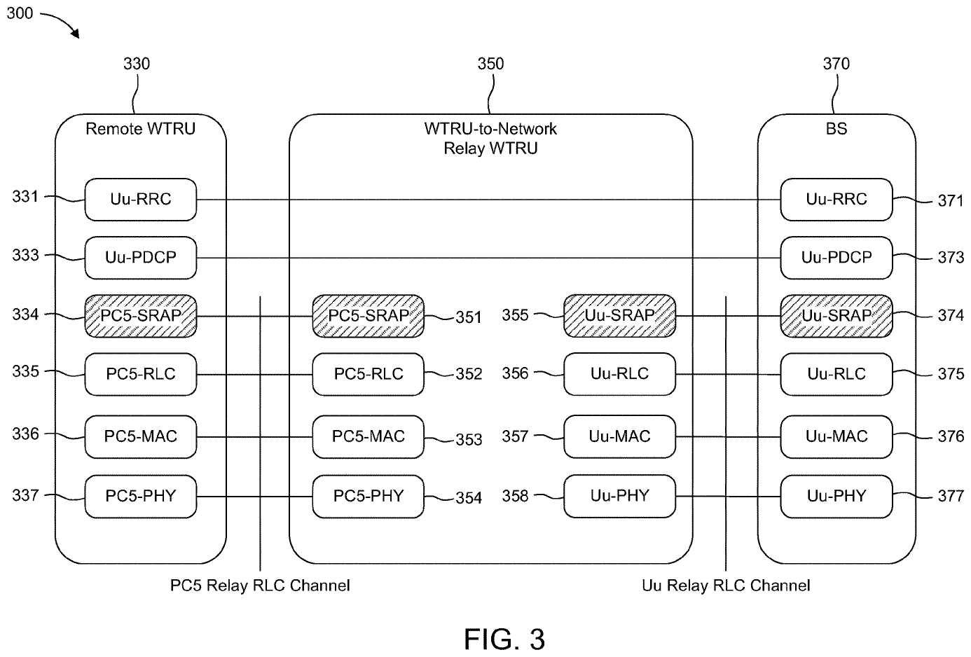

FIG. 2 is a protocol stack diagram illustrating an example user plane protocol stack for a layer 2 (L2) UE-to-network (U2N) relay. Protocol stack diagram 200 also illustrates an example user plane protocol stack for a WTRU-to-network relay. FIG. 3 is a protocol stack diagram illustrating an example control plane protocol stack for an L2 U2N relay. Protocol stack diagram 200 also illustrates an example control plane protocol stack for a WTRU-to-network relay In an example shown in FIG. 2 and FIG. 3, the sidelink relay adaptation protocol (SRAP) sublayer is placed above the radio link control (RLC) sublayer for both the control plane (CP) and user plane (UP) at both the PC5 interface and the Uu interface. For example, as shown in an example in protocol stack diagram 200 for the UP, PC5-SRAP sublayer 234 is placed above PC5-RLC sublayer 235 at remote WTRU 230, and PC5-SRAP sublayer 251 is placed above PC5-RLC sublayer 252 at WTRU-to-Network relay WTRU 250. Similarly, Uu-SRAP sublayer 274 is placed above Uu-RLC sublayer 275 at base station (BS) 270, and Uu-SRAP sublayer 255 is placed above Uu-RLC sublayer 256 at WTRU-to-Network relay WTRU 250. In an example, the BS may be a gNB.

In a similar example shown in protocol stack diagram 300 for the CP, PC5-SRAP sublayer 334 is placed above PC5-RLC sublayer 335 at remote WTRU 330, and PC5-SRAP sublayer 351 is placed above PC5-RLC sublayer 352 at WTRU-to-Network relay WTRU 350. Likewise, Uu-SRAP sublayer 374 is placed above Uu-RLC sublayer 375 at gNB 370, and Uu-SRAP sublayer 355 is placed above Uu-RLC sublayer 356 at WTRU-to-Network relay WTRU 350.

The Uu service data adaptation protocol (SDAP), packet data convergence protocol (PDCP) and radio resource control (RRC) are terminated between the L2 U2N Remote WTRU and the gNB or base station, while the SRAP sublayer, RLC sublayer, MAC layer and physical (PHY) layer are terminated in each hop, for example, the link between L2 U2N Remote WTRU and the L2 U2N Relay WTRU, and the link between L2 U2N Relay WTRU and the gNB or base station.

For example, as shown in protocol stack diagram 200 for the UP, Uu-SDAP sublayer 232 is terminated at remote WTRU 230, and Uu-SDAP sublayer 272 is terminated at base station 270. Also, Uu-PDCP sublayer 233 is terminated at remote WTRU 230, and Uu-PDCP sublayer 273 is terminated at base station 270. Similarly, as shown in protocol stack diagram 300 for the CP, Uu-RRC sublayer 331 is terminated at remote WTRU 330, and Uu-RRC sublayer 371 is terminated at base station 370. Further, Uu-PDCP sublayer 333 is terminated at remote WTRU 330, and Uu-PDCP sublayer 373 is terminated at base station 370.

In comparison, as shown in an example in protocol stack diagram 200 for the UP, PC5-SRAP sublayer 234, PC5-RLC sublayer 235, PC5-MAC layer 236 and PC5-PHY layer 237 may terminate at remote WTRU 230, and PC5-SRAP sublayer 251, PC5-RLC sublayer 252, PC5-MAC layer 253 and PC5-PHY layer 254 may terminate at WTRU-to-Network relay WTRU 250. Similarly, Uu-SRAP sublayer 255, Uu-RLC sublayer 256, Uu-MAC layer 257 and Uu-PHY layer 258 may terminate at WTRU-to-Network relay WTRU 250, and Uu-SRAP sublayer 274, Uu-RLC sublayer 275, Uu-MAC layer 276 and Uu-PHY layer 277 may terminate at base station 270.

Likewise, as shown in an example in protocol stack diagram 300 for the CP, PC5-SRAP sublayer 334, PC5-RLC sublayer 335, PC5-MAC layer 336 and PC5-PHY layer 337 may terminate at remote WTRU 330, and PC5-SRAP sublayer 351, PC5-RLC sublayer 352, PC5-MAC layer 353 and PC5-PHY layer 354 may terminate at WTRU-to-Network relay WTRU 350. In a similar way, Uu-SRAP sublayer 355, Uu-RLC sublayer 356, Uu-MAC layer 357 and Uu-PHY layer 358 may terminate at WTRU-to-Network relay WTRU 250, and Uu-SRAP sublayer 374, Uu-RLC sublayer 375, Uu-MAC layer 376 and Uu-PHY layer 377 may terminate at base station 370.

For an L2 U2N Relay, the SRAP sublayer over PC5 hop is only for the purpose of bearer mapping. The SRAP sublayer is not present over PC5 hop for relaying the L2 U2N Remote WTRU's message on the broadcast control channel (BCCH) and paging control channel (PCCH). For the L2 U 2N Remote WTRU's message on signaling radio bearer (SRB) 0(SRB 0 ), the SRAP header is not present over the PC5 hop, but the SRAP header is present over Uu hop for both DL and UL.

Routing and bearer mapping in an L2 WTRU to network (NW) relay is supported by the SRAP sublayer. For the L2 U2N relay, for uplink, the following may apply. The Uu SRAP sublayer performs UL bearer mapping between ingress PC5 Relay RLC channels for relaying and egress Uu Relay RLC channels over the L2 U2N Relay WTRU Uu interface. For uplink relaying traffic, the different end-to-end Uu Radio Bearers (SRBs or data radio bearers (DRBs)) of the same L2 U2N Remote WTRU and/or different L2 U2N Remote WTRUs can be multiplexed over the same egress Uu Relay RLC channel.

The Uu SRAP sublayer supports L2 U2N Remote WTRU identification for the UL traffic. The identity information of L2 U2N Remote WTRU end-to-end Uu Radio Bearer and a local Remote WTRU ID are included in the Uu SRAP header at UL in order for gNB or base station to correlate the received packets for the specific PDCP entity associated with the right end-to-end Uu Radio Bearer of the L2 U2N Remote WTRU.

The PC5 SRAP sublayer at the L2 U2N Remote WTRU supports UL bearer mapping between L2 U2N Remote WTRU end-to-end Uu Radio Bearers and egress PC5 Relay RLC channels.

For L2 U2N Relay, for downlink, the following may apply. The Uu SRAP sublayer performs DL bearer mapping at the gNB or base station to map end-to-end Uu Radio Bearer (SRB, DRB) of L2 U2N Remote WTRU into Uu Relay RLC channel. The Uu SRAP sublayer performs DL bearer mapping and data multiplexing between multiple end-to-end Radio Bearers (SRBs or DRBs) of a L2 U2N Remote WTRU and/or different L2 U2N Remote WTRUs and one Uu Relay RLC channel over the L2 U2N Relay WTRU Uu interface.

The Uu SRAP sublayer supports L2 U2N Remote WTRU identification for DL traffic. The identity information of L2 U2N Remote WTRU end-to-end Uu Radio Bearer and a local Remote WTRU identity (ID) are included into the Uu SRAP header by the gNB or base station at DL for the L2 U2N Relay WTRU to enable DL bearer mapping between ingress Uu Relay RLC channels and egress PC5 Relay RLC channel.

The PC5 SRAP sublayer at the L2 U2N Relay WTRU performs DL bearer mapping between ingress Uu Relay RLC channels and egress PC5 Relay RLC channels. The PC5 SRAP sublayer at the L2 U2N Remote WTRU correlates the received packets with the right PDCP entity associated with the given end-to-end Radio Bearer of the L2 U2N Remote WTRU based on the identity information included in the PC5 SRAP header.

A local Remote WTRU ID is included in both PC5 SRAP header and Uu SRAP header. L2 U2N Relay WTRU is configured by the gNB or base station with the local Remote WTRU ID(s) to be used in SRAP header. L2 U2N Remote WTRU obtains the local Remote ID from the gNB or base station via Uu RRC messages including RRCSetup, RRCReconfiguration, RRCResume and RRCReestablishment.

The end-to-end DRB(s) or end-to-end SRB(s), except SRB0, of L2 U2N Remote WTRU can be multiplexed to the PC5 Relay RLC channels and Uu Relay RLC channels in both PC5 hop and Uu hop, but an end-to-end DRB and an end-to-end SRB can neither be mapped into the same PC5 Relay RLC channel nor be mapped into the same Uu Relay RLC channel.

It is the responsibility of the gNB or base station to avoid collision on the usage of local Remote WTRU ID. The gNB or base station can update the local Remote WTRU ID by sending the updated local Remote WTRU ID via RRCReconfiguration message. The serving gNB or base station can perform local Remote WTRU ID update independent of the PC5 unicast link L2 ID update procedure.

Examples provided herein include duplication in NR. For example, duplication at the PDCP may include submitting the same PDCP PDUs multiple times.

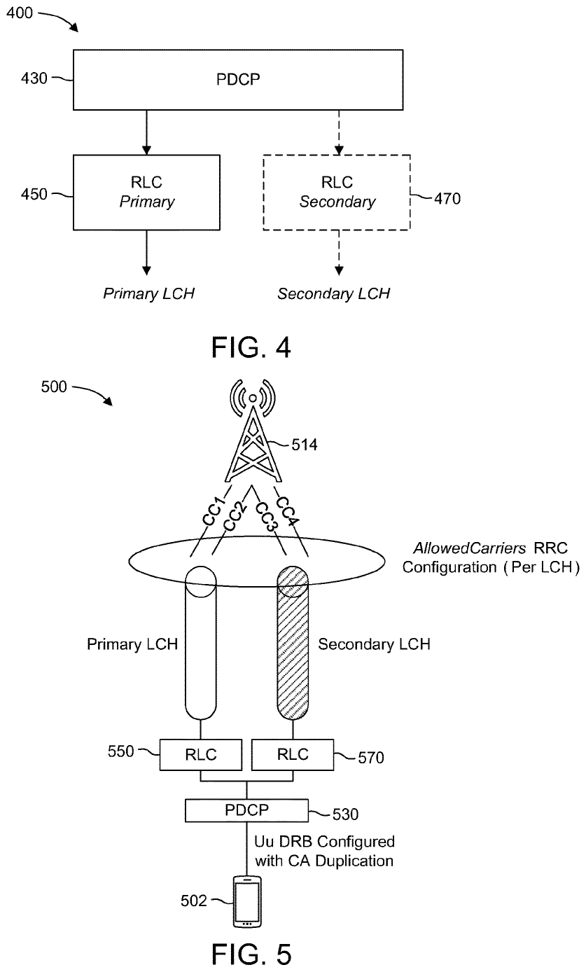

FIG. 4 is a processing diagram illustrating an example of packet duplication. As shown in an example in processing diagram 400, when duplication is configured for a radio bearer by RRC, at least one secondary RLC entity is added to the radio bearer to handle the duplicated PDCP PDUs, where the logical channel corresponding to the primary RLC entity 450 is referred to as the primary logical channel, and the logical channel corresponding to the secondary RLC entity(ies), is/are referred to as the secondary logical channel(s). Examples shown in FIG. 4 include secondary RLC entity 470. All RLC entities have the same RLC mode. Duplication at PDCP entity 430 therefore consists in submitting the same PDCP PDUs multiple times: once to each activated RLC entity for the radio bearer. With multiple independent transmission paths, packet duplication therefore increases reliability and reduces latency and is especially beneficial for URLLC services.

In examples shown in FIG. 4, PDCP control PDUs are not duplicated and always submitted to the primary RLC entity. PDCP data PDUs may be duplicated. For example, a PDCP data PDU may be duplicated by PDCP entity 430 and one PDCP data PDU may be provided to the primary RLC entity 450, and the other PDCP data PDU may be provided to the secondary RLC entity 470. A primary logical channel (LCH) may correspond to the primary RLC entity 450 and a secondary LCH may correspond to the secondary RLC entity 470, in an example shown in FIG. 4.

When configuring duplication for a DRB, RRC also sets the state of PDCP duplication (either activated or deactivated) at the time of configuration, re-configuration, or both. After the configuration, the PDCP duplication state can then be dynamically controlled by means of a MAC control element (CE) and in DC, the WTRU applies the MAC CE commands regardless of their origin (master cell group (MCG) or secondary cell group (SCG). When duplication is configured for an SRB, the state is always active and cannot be dynamically controlled. When configuring duplication for a DRB with more than one secondary RLC entity, RRC also sets the state of each of them (for example, either activated or deactivated). Subsequently, a MAC CE can be used to dynamically control whether each of the configured secondary RLC entities for a DRB should be activated or deactivated, in other words, which of the RLC entities shall be used for duplicate transmission. A primary RLC entity cannot be deactivated. When duplication is deactivated for a DRB, all secondary RLC entities associated with this DRB are deactivated. When a secondary RLC entity is deactivated, it is not re-established, the hybrid automatic repeat request (HARQ) buffers are not flushed, and the transmitting PDCP entity should indicate to the secondary RLC entity to discard all duplicated PDCP PDUs.

When activating duplication for a DRB, next generation radio access network (NG-RAN) should ensure that at least one serving cell is activated for each logical channel associated with an activated RLC entity of the DRB. Further, when the deactivation of SCells leaves no serving cells activated for a logical channel of the DRB, NG-RAN should ensure that duplication is also deactivated for the RLC entity associated with the logical channel.

When duplication is activated, the original PDCP PDU and the corresponding duplicate(s) shall not be transmitted on the same carrier. The logical channels of a radio bearer configured with duplication can either belong to the same MAC entity (referred to as carrier aggregation (CA) duplication) or to different ones (referred to as DC duplication). CA duplication can also be configured in either or both of the MAC entities together with DC duplication when duplication over more than two RLC entities is configured for the radio bearer. In CA duplication, logical channel mapping restrictions are used in a MAC entity to ensure that the different logical channels of a radio bearer in the MAC entity are not sent on the same carrier. When CA duplication is configured for an SRB, one of the logical channels associated to the SRB is mapped to a special cell (SpCell).

When CA duplication is deactivated for a DRB in a MAC entity, for example, when none or only one of RLC entities of the DRB in the MAC entity remains activated, the logical channel mapping restrictions of the logical channels of the DRB are lifted for as long as CA duplication remains deactivated for the DRB in the MAC entity. When an RLC entity acknowledges the transmission of a PDCP PDU, the PDCP entity shall indicate to the other RLC entity(ies) to discard it. In addition, in case of CA duplication, when an RLC entity restricted to only SCell(s) reaching the maximum number of retransmissions for a PDCP PDU, the WTRU informs the gNB or base station but does not trigger radio link failure (RLF).

Modification and enhancements are provided in embodiments and examples herein to allow PDCP duplication for a remote WTRU configured with multipath. Duplication is supported in NR via CA and DC. In NR CA, the network ensures that duplication of packets happens on different carriers by configuring a list of allowed carriers for each of the two LCHs associated with a duplicated bearer.

FIG. 5 is a system diagram illustrating an example of a WTRU selecting logical channels (LCHs) for a grant associated with allowed carriers. As shown in an example in system diagram 500, the WTRU, when performing logical channel prioritization (LCP), can only select LCHs for a grant if the grant is associated with a carrier that is in the list of allowed carriers for that LCH. The list of allowed carriers may be provided by an RRC configuration.

In an example shown in FIG. 5, a WTRU 502, which may be the same as or similar to WTRU 102, in an example, may communicate over a Uu DRB configured with CA duplication. A PDCP data PDU may be duplicated by PDCP entity 530 and may be provided to an RLC entity 550, and the other PDCP data PDU may be provided to an RLC entity 570. A primary LCH may correspond to the RLC entity 550 and a secondary LCH may correspond to the secondary RLC entity 570. The PDCP data PDU may be transmitted over the primary LCH using CC1, CC2 or both, and be received by base station 514. Further, the other PDCP data PDU may be transmitted over the secondary LCH using CC3, CC4 or both, and be received by base station 514. In an example, base station 514 may the same as or similar to base station 114a.

Multipath will support duplication for a bearer that is split over both direct and indirect. To achieve diversity with multipath, similar avoidance of transmitting duplicates over the same Uu carrier should be avoided.

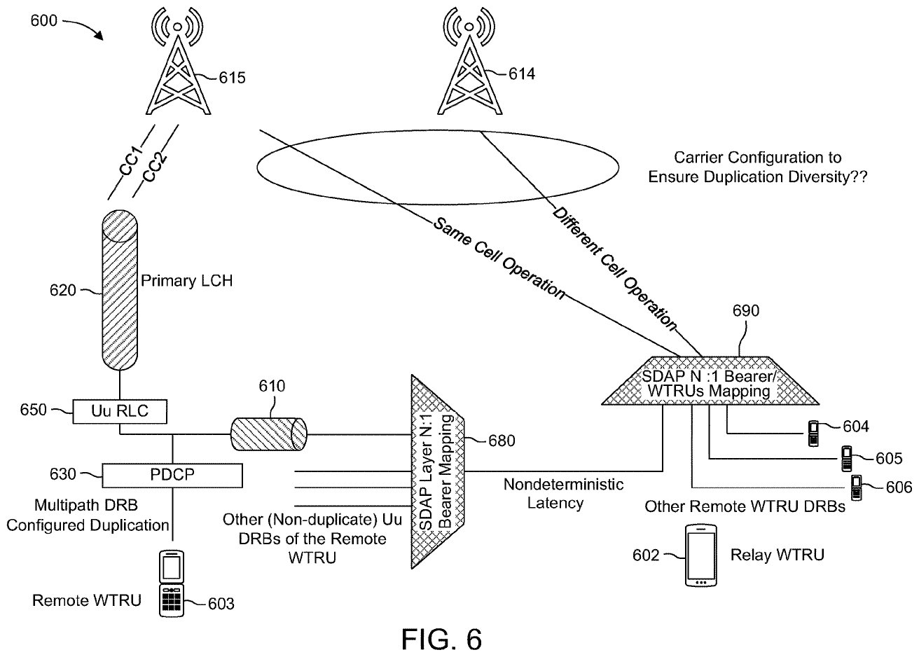

FIG. 6 is a system diagram illustrating an example of a remote WTRU transmitting on one or more Uu carriers and a relay WTRU transmitting on one or more Uu carriers. As shown in an example in system diagram 600, a remote WTRU 603 may communicate over a multipath Uu DRB configured with duplication. A PDCP data PDU may be duplicated by PDCP entity 630 and may be provided to a Uu RLC entity 650. In an example, a primary LCH 620 may correspond to the Uu RLC entity 650. The PDCP data PDU may be transmitted over the primary LCH 620 using CC1, CC2 or both, and be received by base station 615. The other PDCP data PDU may be sent over secondary LCH 610 and may be undergo SDAP layer mapping 680, along with PDU on other, non-duplicate, Uu DRBs of the remove WTRU 603. Subject to nondeterministic latency, the remote WTRU 603 may then transmit the PDUs to a relay WTRU 602.

The relay WTRU 602 may receive the PDUs from the remote WTRU 603. Also, the relay WTRU 602 may receive one or more PDUs from one or more other remote WTRUs, such as remote WTRUs 604, 605, 606, using one or more other remote WTRU DRBs. The relay WTRU may then transmit the PDUs, after applying SDAP N:1 bearer to WTRU mapping, to base station 615 using the same cell operation as the remote WTRU 603. Also, the relay WTRU may transmit the PDUs using different cell operations from the remote WTRU 603 to base station 614. Moreover, the relay WTRU may use a carrier configuration to ensure duplication diversity.

As shown in an example in FIG. 6, the transmission on the Uu carrier at the relay WTRU 602 and the remote WTRU 603 are occurring at different WTRUs. This introduces a number of issues related to how to configure the carriers for transmission at the relay WTRU 602 and the remote WTRU 603, such as those described in the following.

An SDAP layer 680 at the remote 603 WTRU may apply N:1 bearer mapping for uplink transmissions. Similarly, the SDAP layer 680 at the remote 603 WTRU may apply 1:N bearer mapping for downlink transmissions. Likewise, an SDAP layer 690 at the relay 602 WTRU may apply N:1 bearer mapping for uplink transmissions and 1:N bearer mapping for downlink transmissions. Due to N:1/1:N mapping at the adaptation layers at both the remote WTRU 603 and relay WTRU 602, a Uu LCH that is subject to containing duplicated data may more often than not contain non-duplicated data, and duplication may possibly be applicable possibly to most UL LCHs or all UL LCHs at the relay WTRU 602.

The latency of the transmissions over SL may be larger than the Uu channel coherence time, which eliminates the need for ensuring that duplicates are sent on different carriers. The distance between the relay and remote WTRU may be larger enough that duplication on the same Uu carrier is acceptable. Same cell operations, different cell operations, or both, are possible for multipath and may affect the need for configuring carrier restrictions on a Uu link.

For at least these reasons, a static approach of configuring LCHs at both the remote and relay WTRU to be limited to certain carriers (extending directly from NR) may therefore unnecessarily limit the scheduling flexibility of the network and could further delay UL transmissions in some cases. Therefore, modifications of this static approach are provided in embodiments and examples herein.

Embodiments and examples are provided herein of a relay WTRU determining whether to apply carrier restrictions. Examples include an apparatus and method for a relay WTRU to restrict transmission of an SDU to a carrier based on one or more of a duplication indication sent by the remote WTRU, the time taken to transmit the packet over SL, and a configured list of allowable carriers. For example, a relay WTRU may receive, from the network, a threshold time difference over sidelink associated with channel coherence time. Further, the relay WTRU may receive, from the network, a list of allowable carriers associated with a logical channel. Also, the relay WTRU may receive one or more packets from a remote WTRU, along with an indication of whether duplication is applicable, and an SL transmission latency associated to the one or more packets. When selecting data for transmission over Uu, if any of the selected data has SL transmission latency for the packet below a threshold, and duplication is indicated as applicable, the relay WTRU may restrict the transmission to one of the allowed carriers. Otherwise, the relay WTRU may perform transmission to any of the configured UL carriers.

Embodiments and examples are provided herein of a remote WTRU indicating to the relay whether carrier restriction is required. Examples include an apparatus and method for a remote WTRU in multipath to indicate whether carrier restriction for duplication is required by a relay WTRU for relayed traffic and the corresponding set of carriers to be used by the relay based on whether the data is associated with a multipath bearer with duplication activated, the cell ID of the Uu link compared to the cell ID of the relay WTRU, and the delay associated with transmission on SL, for example, the number of times listen-before-talk (LBT) failed for transmission of the packet on sidelink.

For example, a remote WTRU may receive from the network, an index of carriers to be used by the relay, and an indication of whether duplication is activated or deactivated. In an example, the index may be per bearer. The remote WTRU may receive from the network, a threshold amount of delay related to SL transmission. Further, the remove WTRU may receive from the network, a set of configured cell groups. If at least one SL transmission for a multipath bearer has duplication activated, the cell ID of the relay WTRU and the primary cell (PCell) are in the same configured cell group, and the number of LBT failures for transmission of the packet is below a threshold, the remote WTRU may transmit on SL, a MAC CE indicating the index of the carriers to be used by the relay for carrier restriction and the SL-LCHs that have duplication activated.

Embodiments and examples are provided herein of carrier selection/LCP restriction for different data requiring different restriction. Examples include an apparatus and method for a relay WTRU to determine the carrier(s) allowed for the transmission of a TB containing data from a Uu LCH based on the allowed carriers configured for each of the SL LCHs for the different WTRUs, and whether each WTRU has signaled the need for carrier restriction.

For example, a relay WTRU may receive from the network, an adaptation layer configuration which maps incoming SL LCH to one or more Uu LCHs. The relay WTRU may receive from the network, a configuration for a set of allowed carriers for each of the incoming SL LCHs of each remote WTRU. Further, the relay WTRU may receive an indication, from the one or more remote WTRUs, of whether carrier restriction is required for an SL LCH. For a specific Uu LCH, the remote WTRU may select the carrier for transmission of data for the Uu LCH from the intersection of the allowed carriers of each of the remote WTRU's, each of the SL LCHs, or both, that map to the Uu LCH and which have the need for carrier restriction signaled by the remote WTRU. Further, the remote WTRU may transmit the data received of that Uu LCH on the selected carriers.

As used in embodiments and examples herein, the phrase LCP restriction may refer to a condition within LCP where a MAC SDU, or the SDU from a logical channel is not allowed to be multiplexed into a grant, possibly where the grant is on a specific carrier. Further, as used in embodiments and examples herein, the phrase carrier restriction may refer to the need or requirement of transmitting data at the relay WTRU, possibly associated with an SL-LCH in reception, or a Uu LCH in transmission, on a carrier that has sufficient frequency diversity with the duplicate transmission of the same data that was performed by the remote WTRU in multipath. Such frequency diversity can be achieved by restricting the transmission to certain carriers. As used in embodiments and examples herein, such carriers may be referred to in general as allowed carriers.

Example solutions provided herein may be based on the observation that duplicate packets (for PDCP duplication in CA) in Uu are transmitted on carriers configured by a set of allowable carriers to ensure sufficient frequency diversity for the packets. For multipath SL relay, duplicate PDCP packets at the remote WTRU may be transmitted by different WTRUs on one or more Uu links, with the remote WTRU on the direct link, and the relay WTRU on the Uu portion of the indirect link, and accordingly some coordination is required between the WTRUs.

In an example, a relay WTRU may receive one or multiple allowable carrier sets for duplicated multipath data. A relay WTRU may be configured with one or a set of allowable UL carriers to be used for transmission of data from a logical channel associated with relayed data from a remote WTRU. Specifically, a relay WTRU may be configured with an LCH associated with relayed data from one or more remote WTRUs.

In an example solution, a relay WTRU may receive one allowed carrier or a set of allowed carriers to be applied in LCP for a given LCH. Specifically, when the carrier restriction is applied, the relay WTRU may transmit data from the LCH only on one of the configured allowed carriers.

In another example solution, a relay WTRU may receive multiple allowed carriers or multiple sets of allowed carriers to be applied in LCP for a given LCH and may decide which of the allowed carrier or which of the carrier sets that the transmission is allowed on. A WTRU may associate each configured carrier or carrier sets with any one or any combination of a remote WTRU, a type of data carried, measured conditions on SL or Uu, or some information indicated by the remote WTRU, possibly related to remote WTRU measurements, as further explained in the following.

In an example, a WTRU may associate each configured carrier or carrier sets with a remote WTRU. For example, each configured carrier or carrier set may be used by the relay WTRU for transmissions associated with a particular remote WTRU. Specifically, the relay WTRU may receive, along with the allowed carrier or carrier set configuration, an indication of the remote WTRU to which the carrier or carrier set is applicable.

In another example, a WTRU may associate each configured carrier or carrier sets with a type of data carried. For example, each configured carrier or carrier set may be used by the relay WTRU for a specific type of data, such as SRB data versus DRB data, URLLC data versus non-URLLC data, relayed MAC CE information vs relayed data, and the like. For example, the remote WTRU may indicate a data type associated with data received by the relay WTRU, and the relay WTRU may select the carrier or carrier set associated with such data type. For example, such data type may be associated with a type of extended reality (XR) data. In an example, the XR data may include one or more predicted frames (P frames), intra-coded frames (I frames), and the like.

In a further example, a WTRU may associate each configured carrier or carrier sets with measured conditions on SL or Uu. For example, the relay WTRU may be configured with different measurements made by the relay WTRU on sidelink, on a Uu link, or both, as described herein.

In yet another example, a WTRU may associate each configured carrier or carrier sets with some information indicated by the remote WTRU, possibly related to remote WTRU measurements. For example, the relay WTRU may provide an indication over PC5 that allows the relay WTRU to select the carrier or carrier set configured by the gNB or base station.

Details of the selection of the configured carrier or carrier set for these examples are given herein. Furthermore, a carrier or carrier set, whether a single carrier is configured, or multiple carriers are configured can be configured per LCH, where such LCH is associated with relayed data, or may be configured per relay WTRU, for example a common carrier or carrier set to be used for all relayed LCHs at the relay WTRU.

In embodiments and examples provided herein, a relay WTRU may determine whether to apply carrier restriction. For example, a relay WTRU may determine whether to apply a configured allowed carrier or carrier set for a UL transmission. In an example solution, a relay WTRU may determine, for a UL SDU, potentially associated with an LCH, whether such an SDU should be restricted to grants associated with a set of allowed carriers or not. In an example, the UL SDU may be a MAC SDU. Such a decision may be performed on a per SDU level, possibly associated with data on an LCH. Additionally or alternatively, the same decision may be performed for all SDUs, possibly associated with data on an LCH, based on some event which may change the decision.

A relay WTRU may determine whether to restrict transmission of an SDU/PDU to a configured carrier or carrier set based on one or any combination of the following examples. In examples, the configured carrier may be an allowed carrier, and the carrier set may be a set of allowed carriers. Specifically, a WTRU may determine whether to restrict transmission of an SDU/PDU to a configured carrier (or allowed carrier) or carrier set (or set of allowed carriers) based on reception of an indication from the remote WTRU. For example, such an indication may be sent by the remote WTRU to indicate the need for a duplication restriction, and may be determined by the remote WTRU as described elsewhere herein.

For example, a remote WTRU may provide an indication in PC5 to enable carrier restriction, to disable carrier restriction, or both, for any data received from the remote WTRU to be relayed. Such an indication may be received in a PC5-RRC message, or in an SL MAC CE. Such an indication may apply to all data received from that remote WTRU. Additionally or alternatively, such indication may be sent per LCH, (for example sent per SL-LCH.

In one example, a relay WTRU may receive an indication which turns on carrier restriction, turns off carrier restriction, or both associated with a remote WTRU. Additionally or alternatively, a relay WTRU may receive an indication which turns on carrier restriction, turns off carrier restriction, or both associated with an LCH. The relay WTRU may then apply the behavior associated with carrier restriction for all data from that remote WTRU, from that LCH, or both, based on whether carrier restriction was last turned on or off by the remote WTRU. Specifically, when a relay WTRU receives an indication which turns carrier restriction on, the relay WTRU may use only the one or more carriers configured as the one or more allowed carriers to transmit an SDU, a PDU, or both received from the remote WTRU, possibly for a specific LCH. When a relay WTRU receives an indication which turns carrier restriction off, the relay WTRU may use any one or more carriers to transmit the SDU, the PDU, or both on uplink, and may not apply the carrier restriction configured at the relay.

In another example, a relay WTRU may receive such indication per SDU, per PDU, or both. For example, the relay WTRU may receive an SDAP/MAC/RLC PDU/SDU containing an indication ( indicating whether the PDU/SDU carrier restriction should be applied to the SDU/PDU. In examples, the indication may be received in an SL MAC CE, in the header of the PDU, in header of the SDAP, or the like. For example, such indication may be in the form of a single bit in a header. In an example, ‘1’=indication is present=perform exclusion. For example, if the relay WTRU receives a PDU, an SDU, or both from the remote WTRU with the indication present, the relay WTRU may restrict transmission on a Uu link for the PDU, the SDU, or both to the one or more allowed carriers configured for the corresponding restriction. Otherwise, the relay WTRU may select any carrier for transmission. Criteria for the remote WTRU to determine how to set the indication are further described elsewhere herein.

In another example, a WTRU may determine whether to restrict transmission of an SDU, a PDU, or both to a configured carrier or carrier set based on measurements of the SL. In examples, the configured carrier may be an allowed carrier, and the carrier set may be a set of allowed carriers. In an example solution, a relay WTRU may determine whether to restrict transmission to a configured carrier based on one or more SL measurements. For example, if a specific measurement meets a certain criterion, the relay WTRU may restrict transmission to one or more configured carriers in UL. In examples, the criterion may be that the specific measure is above a configured threshold, below a configured threshold, located in a configured range, or the like.

Such measurements may include, but may not be limited to, any one or any combination of: an SL channel busy ration (CBR) above a threshold, below a threshold, or within a range; an SL received signal strength indicator (RSSI) above a threshold, below a threshold, or within a range; sensing information, sensing measurements, or both, determined by the relay WTRU, or received from another WTRU; an SL channel state information (CSI); or an SL reference signal received power (RSRP) of the received data to be relayed by the relay WTRU.

Several examples include sensing information, a threshold measurements, or both, determined by the relay WTRU, or received from another WTRU. For example, a relay WTRU may detect another WTRU, other than the remote WTRU, transmitting sidelink control information (SCI) which indicates transmission in the same resource as the resource used by the remote WTRU to send the data to be relayed by the relay WTRU, possibly where the RSRP of the interfering transmission's SCI is above a threshold. In another example, a percentage of available resources measured by the relay WTRU on SL may be above/below a threshold. In a further example, a relay WTRU may receive sensing results from another WTRU indicating that the resource used by the remote WTRU to transmit data to be relayed by the relay WTRU is occupied by another WTRU.

In an example regarding SL CSI, the measured SL CSI on the resources may be above a threshold. In another example regarding SL CSI, the measured SL CSI on the resources may be below a threshold.

In a further example, a WTRU may determine whether to restrict transmission of an SDU, a PDU, or both, to a configured carrier or carrier set based on measurements of the Uu. In examples, the configured carrier may be an allowed carrier, and the carrier set may be a set of allowed carriers. In an example solution, a relay WTRU may determine whether to restrict transmission to an allowed carrier based on the one or more Uu measurements of one or another carrier. For example, the relay WTRU may restrict transmission to an allowed carrier if the relay WTRU is unable to find a carrier which is not in the list of allowed carriers which has a measurement that satisfies some configured criteria. For example, the relay WTRU may restrict transmission to an allowed carrier if the average measurement over multiple Uu carriers satisfies some criteria. Such measurements may consist of a Uu RSRP above/below a threshold, Uu CSI above/below a threshold, and the like.

In an additional example, a WTRU may determine whether to restrict transmission of an SDU, a PDU, or both, to a configured carrier or carrier set based on a computed distance between the relay WTRU and the remote WTRU. In examples, the configured carrier may be an allowed carrier, and the carrier set may be a set of allowed carriers. In an example solution, a relay WTRU may determine whether to restrict transmission to an allowed carrier or carrier set based on the distance between the relay and remote WTRU. For example, the relay WTRU may determine the distance between itself and the remote WTRU using its own positioning information and positioning information provided by the remote WTRU, for example, in PC5-RRC. For example, the relay WTRU may determine the distance with the remote WTRU based on the use of positioning techniques whereby the relay WTRU computes the relative positioning with the remote WTRU. For example, the relay WTRU may determine the distance with the remote WTRU based on its own configured zone ID and the zone information included in the transmission by the remote WTRU. Other methods for computing distance are not excluded in the embodiments and examples provided herein. For example, a relay WTRU may restrict transmission to an allowed carrier or carrier set if the distance is below a configured threshold.

In yet another example, a WTRU may determine whether to restrict transmission of an SDU, a PDU, or both to a configured carrier or carrier set based on an indication from the network. In examples, the configured carrier may be an allowed carrier, and the carrier set may be a set of allowed carriers. For example, a relay WTRU may receive, from a NW message, an indication of whether a remote WTRU's transmissions, possibly associated with an LCH, should be restricted to an allowed carrier or carrier set. For example, a relay WTRU may receive, for example, in a MAC CE or RRC message any one or any combination of the following: an indication turning on, turning off, or both, a restriction for a specific remote WTRU, an indication turning on, turning off, or both, a restriction for a specific SL-LCH in reception associated with a remote WTRU, or an indication turning on, turning off, or both, a restriction for a specific for a specific Uu LCH associated with relaying.

In still a further example, a WTRU may determine whether to restrict transmission of an SDU, a PDU, or both, to a configured carrier or carrier set based on a network configuration. In examples, the configured carrier may be an allowed carrier, and the carrier set may be a set of allowed carriers. For example, a relay WTRU may be configured with an SL-RLC, an SL-LCH, or both, in reception which requires application of a carrier restriction. Such a configuration may be received from the remote WTRU on PC5-RRC, or from the network on Uu RRC. A relay WTRU may then determine whether the Uu UL transmission requires a carrier restriction based on whether the Uu UL transmission, the LCH, or both are mapped to the SL-RLC, the SL-LCH, or both that are configured with the restriction.

In yet a further example, a WTRU may determine whether to restrict transmission of an SDU, a PDU, or both, to a configured carrier or carrier set based on a buffer occupancy at the relay WTRU. In examples, the configured carrier may be an allowed carrier, and the carrier set may be a set of allowed carriers. For example, a relay WTRU may determine that carrier restriction is applied if the buffer occupancy associated with relaying on the Uu link is below a threshold. Such solution may be motivated by the fact that for large buffer latency, the delay at the relay may ensure sufficient diversity gain without the need of applying a carrier restriction to achieve frequency diversity.

In still another example, a WTRU may determine whether to restrict transmission of an SDU, a PDU, or both, to a configured carrier or carrier set based on QoS of the data. In examples, the configured carrier may be an allowed carrier, and the carrier set may be a set of allowed carriers. Conditions for restriction of the transmission to one or a set of allowed carriers discussed above may further be dependent on the QoS of the data, requirements of the data, or both. Such may be achieved, for example, by configuring the thresholds, the conditions, or both for the factors described above on a per LCH basis, for example. Additionally or alternatively, a relay WTRU may be configured with an SL-LCH in reception or a Uu LCH for relaying which disables carrier restriction, enables carrier restriction, or both, regardless of other conditions herein. For example, if carrier restriction is disabled, the relay WTRU can select any carrier for SDU transmission, PDU transmission, or both; while if carrier restriction is enabled, the relay WTRU may determine whether to perform carrier restriction based on other conditions provided elsewhere herein.

In yet an additional example, a WTRU may determine whether to restrict transmission of an SDU, a PDU, or both, to a configured carrier or carrier set based on latency on SL, which may be indicated by the remote WTRU, or determined by the relay WTRU. In examples, the configured carrier may be an allowed carrier, and the carrier set may be a set of allowed carriers. For example, a relay WTRU may determine that carrier restriction is applied if the transmission latency, for example, indicated by the remote WTRU in the transmission or a previous message, is below a configured threshold. For example, a relay WTRU may determine that carrier restriction is applied if the expected relaying latency at the relay WTRU is below a configured threshold. For example, a relay WTRU may determine that carrier restriction is applied if the relay WTRU receives an indication from the remote WTRU that LBT failed a number of times that is below a configured threshold number of times.

A relay WTRU may follow behavior similar to legacy behavior when it decides to apply carrier restriction to any one of or any combination of PDU transmission, SDU transmission, or LCH transmission. Specifically, a relay WTRU, when it decides to apply carrier restriction, may multiplex data from the LCH or may multiplex data from the SDU, the PDU, or both into a TB on a Uu link only for grants received from a carrier that is part of the allowed carrier list.

In another example solution, a relay WTRU may multiplex a minimum percentage of data onto one or more carriers that are part of the allowed carrier list. For example, the relay WTRU may multiplex at least x %, where x can be configured at the relay WTRU. In another example solution, a relay WTRU may multiplex a maximum percentage of the data onto one or more carriers that are not part of the allowed carrier list. For example, the relay WTRU may multiplex at most y %, where y can be configured at the relay WTRU.

In another example solution, a relay WTRU may multiplex the data on the allowed carrier list except in certain conditions, such as one or both of the following: a failure of a previous transmission, possibly associated with the same remote WTRU, same data type, or same LCH; or a grant on a non-allowed carrier which is indicated by the network to be a high reliability grant.

The relay WTRU may determine the one or more allowed carriers based on mechanisms described in embodiments and examples herein.

In embodiments and examples provided herein, a remote WTRU may indicate to the relay WTRU whether carrier restriction is required. Examples provided herein include conditions for a remote WTRU to indicate application of a carrier restriction, which may include restriction information, to the relay WTRU. In an example solution, a remote WTRU in multipath may be configured with a split bearer allowing duplication. A remote WTRU may indicate to the relay WTRU a carrier restriction requirement, a carrier restriction behavior, or both, to be applied by the relay WTRU. Specifically, a remote WTRU may determine to signal any one or any combination of a carrier restriction, information associated with a carrier restriction, or an indication associated with a carrier restriction, to be sent based on conditions below. A remote WTRU may determine such restriction based on any one or any combination of the following examples.

In an example, a remote WTRU may determine carrier restriction based on conditions, and the conditions may be based on data multiplexed, or that can be multiplexed, for example, via the adaptation layer mapping, into the SL transmission. In an adaptation layer mapping example, a remote WTRU may be configured with PDCP duplication for a split bearer over multipath. The remote WTRU may further be configured with a 1:1 or N:1 mapping on an RLC leg to an SL RLC channel. In an example, the RLC leg may be of the split bearer on a Uu link. Specifically, in an N:1 mapping at the adaptation layer, the remote WTRU may multiplex multiple Uu bearers, or RLC legs of a split Uu bearer, to a single SL-RLC channel.

In such case, a remote WTRU may determine to signal a restriction to the relay WTRU when one or both of the following examples occur. For example, the Uu bearer is a split bearer configured with duplication and the adaptation layer maps the RLC leg of the Uu bearer 1:1 to an SL-RLC channel. In such case, the remote WTRU may signal a restriction associated with the SL-RLC channel.

In another example, the Uu bearer is a split bearer configured with duplication and the adaptation layer maps the RLC leg of the Uu bearer, as well as other Uu bearers in an N:1 fashion on the same SL-RLC channel. In such case, the remote WTRU may indicate the restriction if one or more of the following examples occur. In an example, at least one Uu bearer mapped to SL-RLC channel is a split bearer configured with duplication. In another example, at least X Uu bearers mapped to the SL-RLC channel is a split bearer configured with duplication, where X can be configured by the network, or may be a predetermined value, or may depend on other factors at the WTRU herein. In a further example, all Uu bearers mapped to the SL-RLC channel are split bearers configured with duplication.

In a further example, the conditions may be based on actual data contained in the transmitted PDU. For example, a remote WTRU may determine whether to signal the restriction based on the presence of data in a transmitted PDU which comes from the leg of a Uu split bearer configured with duplication. For example, the remote WTRU may signal a restriction to the relay WTRU for a MAC PDU if the MAC PDU contains any data, for example at least one MAC SDU, from a leg of a Uu split bearer configured with duplication. For example, the remote WTRU may signal a restriction to the relay WTRU for a MAC PDU if the MAC PDU contains only data, for example, all MAC SDUS, from a leg of a Uu split bearer configured with duplication. For example, the remote WTRU may signal a restriction to the relay WTRU for a MAC PDU if the MAC PDU contains at least an amount of data for example from one or more legs of a Uu split bearer configured with duplication. In examples, the amount of data may be in terms of bytes, or in terms of multiplexed PDUs.

Further, a remote WTRU may determine carrier restriction based on conditions, and the conditions may be based on the success/failure of Uu transmissions. For example, the remote WTRU may determine whether to indicate a carrier restriction to the relay WTRU based on the success/failure of one or more past Uu transmissions. For example, if a Uu transmission associated with a split bearer with duplication fails on the UL, the remote WTRU may trigger indication of carrier restriction to the relay WTRU, possibly for the corresponding duplicate, a future duplicate, and/or multiple future duplicates. In a further example, failure on a Uu link may consist of, but may not be limited to, any one or any combination of the following: reception of one or more HARQ negative acknowledgements (NACKs) from a gNB or base station, reception of a failure indication/message from the gNB or base station, transmission of the PDU after the timing requirements associated with the PDU, or UL LBT failure.

Also, a remote WTRU may determine carrier restriction based on conditions, and the conditions may be based on the success, the failure, or both of SL transmissions. For example, the remote WTRU may determine whether to indicate a carrier restriction to the relay WTRU based on the success, the failure, or both, of one or more past SL transmissions. For example, if an SL transmission associated with a split bearer with duplication fails on SL, the remote WTRU may trigger indication of carrier restriction to the relay WTRU, possibly for the corresponding duplicate, future duplicate, and/or multiple future duplicates. In a further example, failure on SL may consist of, but may not be limited to, any one or any combination of the following: reception of one or more HARQ NACKs from relay WTRU, reception of a failure indication/message from the relay WTRU, transmission of the PDU after the timing requirements associated with the PDU, reception of a pre-emption by the remote WTRU associated with a transmission, or a determination that the transmission is made on a resource with sensing results indicating that interference is above a threshold.

In addition, a remote WTRU may determine carrier restriction based on conditions, and the conditions may be related to the carrier selected for the UL (direct) transmission associated with the split bearer. For example, a remote WTRU may select a carrier or carrier set for UL transmission of a duplicate or a leg of a split bearer for duplication. Such selection may be for one or more PDUs associated with the split bearer. Such selection may persist for a period of time. For example, when the remote WTRU selects a carrier or carrier set for a split bearer, the remote WTRU may continue to use the same carrier or carrier set for subsequent transmissions. Based on the selection of the carrier or carrier set, the remote WTRU may transmit an indication that is configured with that carrier or carrier set. For example, the indication may be or may include one or more of an index, a single bit indication, and the like, that is configured for that carrier or carrier set.

In a further example, a remote WTRU may determine carrier restriction based on conditions, and the conditions may be based on SL measurements. For example, a remote WTRU may determine the indication or decide to send the indication based on measurements on SL, such as CBR, channel occupancy ratio (CR), SL RSRP, sensing results, indication of pre-emption, and the like. For example, a remote WTRU may be configured with a condition associated with any SL measurements for sending a restriction indication to the relay WTRU. The condition may be or may include (for example, a CBR may be greater than (>) a threshold, an SL-RSRP of other WTRU transmissions may be greater than (>) a threshold as per sensing results, and the like, in examples.

In another example, a remote WTRU may determine carrier restriction based on conditions, and the conditions may be based on Uu measurements. For example, a remote WTRU may send the duplication indication if the Uu measurements meet some configured condition, for example, a Uu RSRP below a threshold.

In an additional example, a remote WTRU may determine carrier restriction based on whether duplication is enabled, duplication is disabled, or both, at the remote WTRU. For example, a remote WTRU may send the restriction indication if duplication is enabled at the remote WTRU, possibly for a bearer, and may not send the restriction indication if duplication is disabled at the remote WTRU.

In yet a further example, a remote WTRU may determine carrier restriction based on an indication associated with the SL grant. For example, a remote WTRU may send a restriction indication based on information associated with the SL grant, for example in downlink control information (DCI), or associated with a configured grant. For example, the DCI associated with the SL grant may implicitly/explicitly indicate whether/which restriction indication to transmit.

In yet another example, a remote WTRU may determine carrier restriction based on conditions, and the conditions may be based on the type of data. For example, a remote WTRU may receive data of a specific type, where the type may be associated with an upper layer information element, for example, a type of frame in XR, a DCR message in sidelink, and the like. Based on such indication from the upper layers, the remote WTRU may send the restriction indication.

In yet an additional example, a remote WTRU may determine carrier restriction based on conditions, and the conditions may be based on expected latency for the SL transmission. For example, a remote WTRU may determine the restriction indication based on the latency associated with the SL transmission, which may consist of any one or any combination of the following. The determination may be based on the number of LBT failures associated with the SL transmission. Additionally or alternatively, the determination may be based on whether the SL transmission being sent initially triggered an LBT failure, or triggered an LBT failure for the previous PDU transmission. Additionally or alternatively, the determination may be based on a function of the one or more resources selected, the one or more resources used, or both, for transmission on the SL. For example, if the resource is located at least/most x slots from the beginning/end of the resource selection window (for mode 2), the remote WTRU may send the restriction indication.

In still a further example, a remote WTRU may determine carrier restriction based on conditions, and the conditions may be based on the QoS of the data. For example, a remote WTRU may determine whether to send a restriction indication to the relay WTRU based on the QoS of the data being duplicated by the remote WTRU. Such an example solution may be implemented by configuring the behavior per split bearer. Specifically, a remote WTRU may be configured whether the remote WTRU can send a restriction indication to the relay for a specific split bearer. For example, a remote WTRU may send a restriction indication only for split bearers configured to allow sending a restriction indication.

Examples are provided herein regarding the contents of the restriction indication. A restriction indication may take the form of one or more of the following. A restriction indication may take the form of a single bit indication. Specifically, the remote WTRU may send a single bit indicating whether (for example, a 1) or not (for example, a 0) to apply a carrier restriction to the relayed data associated with the split bearer.

A restriction indication may take the form of a carrier or a set of carriers on one or more Uu links. For example, the remote WTRU may send one or more UMTS radio frequency channel number (URFCN) or carrier frequencies. For example, the remote WTRU may send one or more indices referencing one or more carriers configured to the WTRU by the network, or exchanged between the relay and the remote WTRU. For example, the remote WTRU may be configured with a number of carrier sets (for example, set 1, set 2, set 3, and the like), and a corresponding index value (for example 1, 2, 3, and the like). If the remote WTRU selects a carrier from a carrier set, the remote WTRU may send the corresponding index value as the restriction indication, for example, the index of the selected carrier.

A restriction indication may take the form of a set of carrier indices configured for each carrier in a carrier set from which the WTRU has selected to transmit on a carrier in that set. Specifically, the remote WTRU may send a list of indices, where each index is associated with a carrier index configured for the carrier associated with the set of carriers on which a transmission is made. For example, if the remote WTRU performs UL transmission on carrier with index 1, and is configured such that the carrier set contains the carriers with index 1, 2, 3, and 4, the remote WTRU may send indices 1, 2, 3, and 4 to the relay WTRU.

Example mechanisms for signaling the carrier restriction to the relay WTRU are provided herein. A restriction indication may be sent in a MAC CE, where such MAC CE may contain an LCH ID, bearer ID, or similar, as well as any information described herein, such as, for example, a carrier index. A restriction indication may be sent in a protocol header. In an example, the protocol header may be or may include one or more of a MAC header, an RLC header, an SDAP header, and the like. A restriction indication may be sent in SCI, for example, with a single bit indicating the corresponding transmission is for restriction or not.

Embodiments and examples provided herein include carrier selection, LCP restriction, or both, for different data requiring different restrictions. In an example, a relay WTRU may select a carrier for a remote WTRU or a carrier set for a remote WTRU.

In an example solution, a relay WTRU configured with multiple carrier or carrier sets may select one of these configured carriers or carrier sets to be used as the allowed carriers, possibly for associated with one remote WTRU. For example, a relay WTRU may be configured with multiple allowed carrier sets, for example, set A, set B, and set C, where each carrier set contains one or more Uu carriers for UL transmissions. A relay WTRU may determine, following determining the need to perform carrier restriction for a specific remote WTRU, which carrier set to use for the restriction based on any or a combination of the following factors.

For example, a relay WTRU may determine which carrier set to use for the restriction based on information received/exchanged from/with the remote WTRU, possibly combined with a network configuration. The determination may be based on reception of carrier frequencies, in an example. For example, a relay WTRU may receive one or more Uu carrier frequencies and may determine the allowed carriers or carrier set as any other carrier, which may be configured by the network or base station, except the received carrier.

In another example, the determination may be based on reception of an explicit index, possibly following exchange with the peer WTRU. In an example, the peer WTRU may be a remote WTRU. For example, a relay WTRU may receive, from the remote WTRU, an index to one of the configured carriers or carrier sets. For example, the relay WTRU may provide, to the remote WTRU, for example, in PC5-RRC signaling, an indexed list of carrier sets provided to it the network, and the remote WTRU may then indicate the carrier or carrier set by indicating the index in the indexed list.

In another example, the relay WTRU may determine which carrier set to use for the restriction based on the number of carriers in the carrier set. For example, a relay WTRU may, in case multiple carrier sets can be considered allowed for a remote WTRU, select the allowed carrier set to be the carrier set with the largest of carriers or the smallest number of carriers.

In a further example, the relay WTRU may determine which carrier set to use for the restriction based on the QoS of the data associated with the remote WTRU. For example, a relay WTRU may, in case multiple carrier sets can be considered allowed for a remote WTRU, select the allowed carrier set to be the carrier set with the largest number of carriers if the priority of the remote WTRU's transmissions is above a threshold, or the carrier set with the smallest number of carriers if the priority of the remote WTRU's transmissions is below a threshold.

In an additional example, the relay WTRU may determine which carrier set to use for the restriction based on the buffer status associated with LCHs received from the remote WTRU. For example, a relay WTRU may use a first carrier set, for example, a carrier set with the maximum number of carriers, if the buffer status associated with a remote WTRU is larger than a threshold, or may use a second carrier set, for example, a carrier set with the minimum number of carriers, if the buffer status associated with a remote WTRU is below a threshold.

In yet a further example, the relay WTRU may determine which carrier set to use for the restriction based on the load at the relay WTRU. For example, a relay WTRU may be configured with two different allowable carrier sets and may use a first allowable carrier set if the load at the relay is above a threshold, and a second allowable carrier set otherwise.

In another example, a relay WTRU may determine one or more carriers as allowed carriers for a Uu LCH. The determination of an allowed carrier for Uu transmissions for a Uu LCH may be based on static mapping between the Uu LCH and the carrier.

In an example solution, a relay WTRU may determine an allowed carrier or allowed carriers for a Uu LCH based on the remote WTRU transmissions which are multiplexed onto the Uu LCH and the allowable carriers for each remote WTRU. Specifically, a relay WTRU may be configured with an adaptation layer mapping that maps SL transmissions from multiple WTRUs onto the same Uu LCH. Furthermore, the relay WTRU may receive, from each remote WTRU, an indication of whether carrier restriction is required. Additionally or alternatively, the relay WTRU may determine whether carrier restriction is required for a remote WTRU based on methods described herein.

Based on the determination of carrier restriction required for each of the remote WTRUs, a relay WTRU may determine a set of allowable carriers which can be used for a Uu LCH. In one example, a relay WTRU may determine the allowable carriers for a Uu LCH as the intersection of the allowable carriers associated with each remote WTRU which indicates/requires carrier restriction. In another example, a relay WTRU may determine the allowable carriers for a Uu LCH as the set of carriers which can serve as allowable carriers for a majority, for example, at least x %, where x may be preconfigured, of the remote WTRU's whose SL transmissions are multiplexed on the Uu LCH. In another example, a relay WTRU may determine the allowable carriers for a Uu LCH as the set of carriers which can serve as allowable carriers for all remote WTRUs which indicate/require carrier restriction and for which the SL LCH mapped to the Uu LCH is above a configured priority.

In a further example, a relay WTRU may handle a case where no allowed carrier can be found. The determination of an allowed carrier for Uu transmissions may be based on the data that is multiplexed in the TB at the time of transmission. Such an example solution may be used if the previous solution, for example, a static mapping of Uu LCH to allowed carrier, is not possible based on the adaptation layer configuration provided by the network.

In an example solution, a relay WTRU may select a carrier from the set of allowed carriers for transmission of data on a Uu LCH. Based on such selection, the relay WTRU may then allow only subsequent data to be multiplexed in the TB if the data is associated with data that is allowed on the carrier. A relay WTRU may select the carrier based on any one or any combination of the following.

In an example, The relay WTRU may randomly select a carrier that is an allowed carrier for the first packet associated with the Uu LCH. In another example, relay WTRU may randomly select a carrier that is an allowed carrier for the packet with the shortest time requirements to be transmitted on the Uu LCH. In a further example, relay WTRU may select an allowed carrier for transmission of the first packet that arrives in the buffers at the relay WTRU to be transmitted on the Uu LCH, such that the selection of the specific allowed carrier allows transmissions for the largest number of remote WTRUs and/or the largest amount of data requiring a carrier restriction.

Examples provided herein include LCP restriction for data not requiring carrier restriction. In an example solution, a relay WTRU may be configured with an LCP restriction associated with the carriers to be used for data and/or Uu LCHs which are not indicated as requiring a carrier restriction. In such an LCP restriction, a relay WTRU may allow transmission of such data or such Uu LCH only on carriers which are not any of the carriers indicated/configured as allowed carriers for one or more remote WTRUs/LCHs. Specifically, a relay WTRU may be configured with an overall set of carriers, and may be configured with one or more allowed carrier sets which are associated with different remote WTRUs. Upon determining to transmit data in UL which is not associated with any carrier restriction, the relay WTRU may allow transmission of such data only on a configured carrier in the overall set of carriers which does not belong to any of the sets of allowed carriers. Such restriction may be applied individually to SDUs to be relayed to UL by the relay WTRU, if carrier restriction is indicated per SDU, or is indicated per SL-LCH and the adaptation layer identifies the SDU that is mapped to the Uu LCH. Such restriction may be applied per Uu LCH, if the carrier restriction is indicated or determined per Uu LCH using methods described herein.

In an additional or an alternate example solution, a relay WTRU may be configured with an LCP restriction whereby data which is not associated with any carrier restriction cannot be sent on a carrier that is associated with a specific set of allowed carriers, for example, for a single carrier restriction of multiple carrier restrictions that could be configured or indicated at the relay WTRU.

Examples provided herein include LCP restriction for data not requiring carrier restriction, which can be applied based on conditions. In an example solution, a relay WTRU may apply an LCP restriction on data not requiring carrier restriction only based on certain restrictions. The motivation for such behavior is to allow sufficient space in grants on the allowed carriers for transmission of data being duplicated and requiring carrier restriction, so that the grants are not consumed by the data not requiring the carrier restriction.

A relay WTRU may apply the LCP restriction in the previous solution based any one of or a combination of any of the following conditions. A condition may be related to the amount of data available for transmission, possibly associated with a carrier restriction. In an example case, the restriction may be based on the amount of data available for transmission or buffered at the relay WTRU, possibly where this considers the data having a carrier restriction. For example, if the total amount of data at the relay WTRU that is associated with a carrier restriction is above a threshold, the relay WTRU may apply the LCP restriction. For example, if the amount of data associated with a carrier restriction that requires the use of a specific allowed carrier or carrier set is above a threshold, the relay WTRU may apply the LCP restriction only to the specific set of allowed carriers. In an example, the threshold may be configured for a given allowed carrier set.

A condition may be related to the QoS of the data available for transmission, possibly associated with a carrier restriction. In another example case, the restriction may be based on the QoS of the data available for transmission or buffered at the relay WTRU, or of the one or more SL LCHs configured at the relay WTRU, which are associated with the carrier restriction. For example, the relay WTRU may apply the LCP restriction if the priority of any data available for transmission and associated with a carrier restriction is above a configured threshold. For example, the relay WTRU may apply the LCP restriction if the priority of any SL-LCH that has carrier restriction enabled is above a configured threshold.

A condition may be related to the QoS of the data not associated with the carrier restriction, available for transmission. For example, a relay WTRU may apply the LCP restriction if the priority of the data to be transmitted is below a configured threshold. For example, the data to be transmitted may have a lower priority than a configured threshold. This ensures that high priority data which is not associated with a carrier restriction can use any carrier available for transmission.

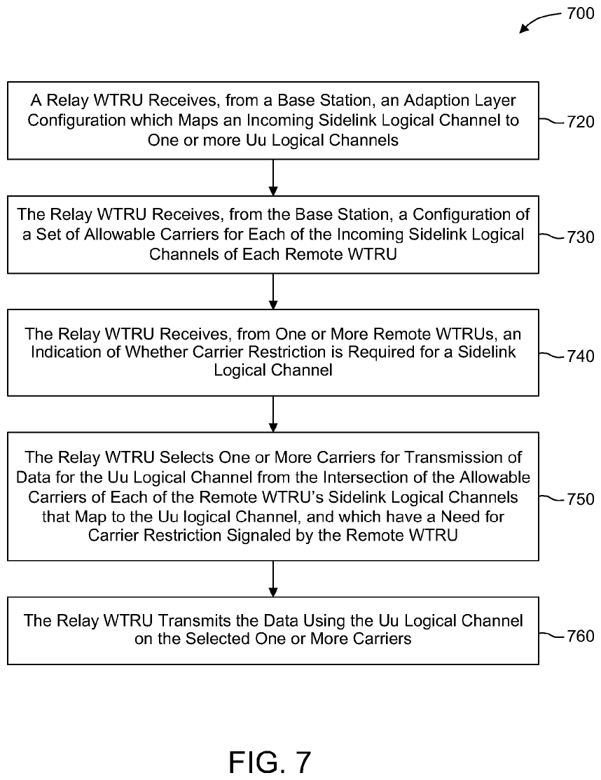

FIG. 7 is a flow chart diagram illustrating an example of a relay WTRU performing carrier selection/LCP restriction for different data requiring different restrictions. As shown in an example in flow chart diagram 700, a relay WTRU may receive, from the network or from a base station, an adaptation layer configuration which maps an incoming SL LCH to one or more Uu LCHs 720. Further, the relay WTRU may receive, from the network or from the base station, a configuration of a set of allowable carriers for each of the incoming SL LCHs of each remote WTRU 730. The relay WTRU may receive, from one or more remote WTRUs, an indication of whether carrier restriction is required for a SL LCH 740. Also, the relay WTRU may select one or more carriers for transmission of data for the Uu LCH from the intersection of the allowable carriers of each of the remote WTRU's SL LCHs that map to the Uu LCH, and which have the need for carrier restriction signaled by the remote WTRU 750. Moreover, the relay WTRU may then transmit the data using the Uu LCH on the selected one or more carriers 760.

In an example, the indication of whether carrier restriction is required for a SL LCH may be received via a MAC CE. The relay WTRU may transmit the data to a base station, in an example. In another example, the relay WTRU may then transmit the data to a plurality of base stations.

In another example, the relay WTRU may determine which carrier set to use for the restriction based on information received from, exchanged with, or both, the remote WTRU, possibly combined with a network configuration. Further, the relay WTRU may determine which carrier set to use for the restriction based on the number of carriers in the carrier set. Also, the relay WTRU may determine which carrier set to use for the restriction based on the QoS of the data associated with the remote WTRU. Moreover, the relay WTRU may determine which carrier set to use for the restriction based on the buffer status associated with LCHs with data received from the remote WTRU. In addition, the relay WTRU may determine which carrier set to use for the restriction based on the load at the relay WTRU. Further, the relay WTRU may determine which carrier set to use for the restriction based on the load at one or more remote WTRUs. In examples, different carriers sets may be used for different data.

In a further example, the relay WTRU may select one or more carriers for transmission based on one or more SL transmissions multiplexed on the Uu LCH. In another example, the relay WTRU may select one or more carriers for transmission based on a configured priority. Further, the relay WTRU may then transmit data for the Uu LCH on the selected one or more carriers.

Although features and elements are described above in particular combinations, one of ordinary skill in the art will appreciate that each feature or element can be used alone or in any combination with the other features and elements. Also, one of ordinary skill in the art will appreciate that features and elements are described above include means to perform the methods described herein. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, a vehicle, a drone, a relay node, or any host computer.

1. A method for use in a relay wireless transmit/receive unit (WTRU), the method comprising:
receiving, from a base station, configuration information which maps incoming sidelink (SL) logical channels (LCHs) of one or more remote WTRUs to one or more Uu LCHs;
receiving, from the base station, a configuration of a set of allowable carriers for each of the incoming SL LCHs of each of the one or more remote WTRUs.
receiving, from the one or more remote WTRUs, one or more indications of whether carrier restriction is required for each of the incoming SL LCHs of each of the one or more remote WTRUs;
selecting one or more carriers for transmission of data for a Uu LCH from allowable carriers, from the set of allowable carriers, of each of SL LCHs of the one or more remote WTRUs that map to the Uu LCH, based on the one or more indications, received from the one or more remote WTRUs, of whether carrier restriction is required for each of the incoming SL LCHs of each of the one or more remote WTRUs; and
transmitting data using the Uu LCH on the selected one or more carriers.

2. The method of claim 1, wherein the one or more indications of whether carrier restriction is required for each of the incoming SL LCHs of each of the one or more remote WTRUs are received via one or more medium access control (MAC) control elements (CEs).

3. The method of claim 1, wherein the data is transmitted to the base station.

4. The method of claim 1, wherein the data is transmitted to a plurality of base stations.

5. The method of claim 1, wherein the selection is based on a number of carriers in the set of allowable carriers.

6. The method of claim 1, wherein the selection is based on a quality of service (QOS) of the data.

7. The method of claim 1, wherein the selection is based on a buffer status of each the incoming SL LCHs.

8. The method of claim 1, wherein the selection is based on a load at the one or more remote WTRUs.

9. The method of claim 1, wherein the base station is a gNode B (gNB).

10. A relay wireless transmit/receive unit (WTRU) comprising:
a transceiver; and
a processor operatively coupled to the transceiver; wherein:
the transceiver is configured to receive, from a base station, configuration information which maps incoming sidelink (SL) logical channels (LCHs) of one or more remote WTRUs to one or more Uu LCHs;
the transceiver is configured to receive, from the base station, a configuration of a set of allowable carriers for each of the incoming SL LCHs of each of the one or more remote WTRUs.
the transceiver is configured to receive, from the one or more remote WTRUs, one or more indications of whether carrier restriction is required for each of the incoming SL LCHs of each of the one or more remote WTRUs;
the processor is configured to select one or more carriers for transmission of data for a Uu LCH from allowable carriers, from the set of allowable carriers, of each of SL LCHs of the one or more remote WTRUs that map to the Uu LCH, based on the one or more indications, received from the one or more remote WTRUs, of whether carrier restriction is required for each of the incoming SL LCHs of each of the one or more remote WTRUs; and
the transceiver and the processor are configured to transmit data using the Uu LCH on the selected one or more carriers.

11. The relay WTRU of claim 10, wherein the one or more indications of whether carrier restriction is required for each of the incoming SL LCHs of each of the one or more remote WTRUs are received via one or more medium access control (MAC) control elements (CEs).

12. The relay WTRU of claim 10, wherein the data is transmitted to the base station.

13. The relay WTRU of claim 10, wherein the data is transmitted to a plurality of base stations.

14. The relay WTRU of claim 10, wherein the selection is based on a number of carriers in the set of allowable carriers.

15. The relay WTRU of claim 10, wherein the selection is based on a quality of service (QOS) of the data.

16. The relay WTRU of claim 10, wherein the selection is based on a buffer status of each the incoming SL LCHs.

17. The relay WTRU of claim 10, wherein the selection is based on a load at the one or more remote WTRUs.

18. The relay WTRU of claim 10, wherein the base station is a gNode B (gNB).
